(19) United States
(12) Patent Application Publication
(10) Pub. No.: US 2018/0365849 A1
(43) Pub. Date: Dec. 20, 2018

(54) PROCESSING DEVICE AND PROCESSING SYSTEM

(71) Applicant: KABUSHIKI KAISHA TOSHIBA, Tokyo (JP)

(72) Inventors: Yasunori TAGUCHI, Kawasaki (JP); Nao MISHIMA, Tokyo (JP); Yasuko YAMANAKA, Tokyo (JP)

(73) Assignee: KABUSHIKI KAISHA TOSHIBA, Tokyo (JP)

(21) Appl. No.: 15/904,282

(22) Filed: Feb. 23, 2018

(30) Foreign Application Priority Data
Jun. 19, 2017 (JP) 2017-119800

(51) Int. Cl. G06T 7/571; G06T 5/00; G06T 5/50; G06T 7/90; G05D 1/02; B60W 30/09

(52) U.S. Cl. CPC G06T 7/571; G06T 5/002; G06T 5/50; G06T 7/90; B60W 2420/42; B60W 30/09; G06T 2207/10024; G06T 2207/30261; G05D 1/0246

(57) ABSTRACT

According to one embodiment, a processing device includes a storage and a hardware processor. The storage is configured to store a third image and a third color component image. The third image is obtained by applying a blur changing filter to a second color component image included in a second image. The blur changing filter changes a blur shape of a first color component image included in a first image. The third color component image is included in the second image. The hardware processor is configured to calculate an evaluation value, based on the third image and the third color component image.

### CROSS-REFERENCE TO RELATED APPLICATIONS

This application is based upon and claims the benefit of priority from Japanese Patent Application No. 2017-119800, filed Jun. 19, 2017, the entire contents of which are incorporated herein by reference.

### FIELD

Embodiments described herein relate generally to a processing device and a processing system.

### BACKGROUND

Generally, technology for acquiring distance information showing a distance to a subject existing in a range (hereinafter, referred to as an imaging range) where an image is captured by an imaging device (camera), based on the image captured by the imaging device, is known.

According to this imaging device, a difference of distance information of an image captured when an object does not exist and distance information of an image where the object exists and a position of other object does not change is used, so that it is possible to detect the presence or absence of the object in the imaging range. Therefore, the imaging device can be used as a monitoring camera or the like, for example.

However, as described above, when the presence or absence of the object is detected, it is necessary to calculate (acquire) the distance information from the images. Therefore, a calculation cost is high.

### BRIEF DESCRIPTION OF THE DRAWINGS

FIG. 1 is a block diagram showing an example of a hardware configuration of an imaging device according to a first embodiment;

FIG. 2 is a diagram for explaining an example of a filter;

FIG. 3 is a diagram showing an example of transmittance characteristics of a first filter region and a second filter region;

FIG. 4 is a diagram showing an example of a functional configuration of the imaging device;

FIG. 5 is a flowchart showing an example of a processing procedure of preprocessing;

FIG. 6 is a diagram for conceptually explaining an R image;

FIG. 7 is a diagram for conceptually explaining a B image;

FIG. 8 is a diagram showing that a size of a blur shape of the R image changes according to a distance;

FIG. 9 is a diagram showing that a size of a blur shape of a G image changes according to the distance;

FIG. 10 is a diagram showing that a size of a blur shape of the B image changes according to the distance;

FIG. 11 is a diagram for explaining a blur shape in an edge region in an image;

FIG. 12 is a diagram for explaining the case where a blur changing filter is applied to the blur shape of the R image;

FIG. 13 is a diagram showing an example of blur functions representing the blur shape of the R image and the blur shape of the G image;

FIG. 14 is a diagram showing an example of a blur changing filter corresponding to a distance d1;

FIG. 15 is a diagram showing an example of a blur changing filter corresponding to a distance d2;

FIG. 16 is a diagram showing an example of a blur changing filter corresponding to a distance d3;

FIG. 17 is a flowchart illustrating an example of a processing procedure of evaluation processing;

FIG. 18 is a block diagram showing an example of a functional configuration of a monitoring system to which the imaging device is applied;

FIG. 19 is a block diagram showing an example of a functional configuration of an automatic door system to which the imaging device is applied;

FIG. 20 is a block diagram showing an example of a functional configuration of a vehicle control system to which the imaging device is applied;

FIG. 21 is a diagram showing an example of a state in which the imaging device is installed in a vehicle;

FIG. 22 is a diagram for explaining a monitoring area;

FIG. 23 is a diagram for explaining the monitoring area;

FIG. 24 is a diagram for explaining the case where a monitoring area is set to a 3D point cloud;

FIG. 25 is a diagram for explaining the case where the monitoring area is set to the 3D point cloud;

FIG. 26 is a diagram for conceptually explaining an operation of an imaging device according to a second embodiment; and

FIG. 27 is a flowchart illustrating an example of a processing procedure of evaluation processing.

### DETAILED DESCRIPTION

In general, according to one embodiment, a processing device includes a storage and a hardware processor. The storage is configured to store a third image and a third color component image. The third image is obtained by applying a blur changing filter to a second color component image included in a second image. The blur changing filter changes a blur shape of a first color component image included in a first image. The third color component image is included in the second image. The hardware processor is configured to calculate an evaluation value, based on the third image and the third color component image.

Various embodiments will be described hereinafter with reference to the accompanying drawings.

### First Embodiment

First, a first embodiment will be described.

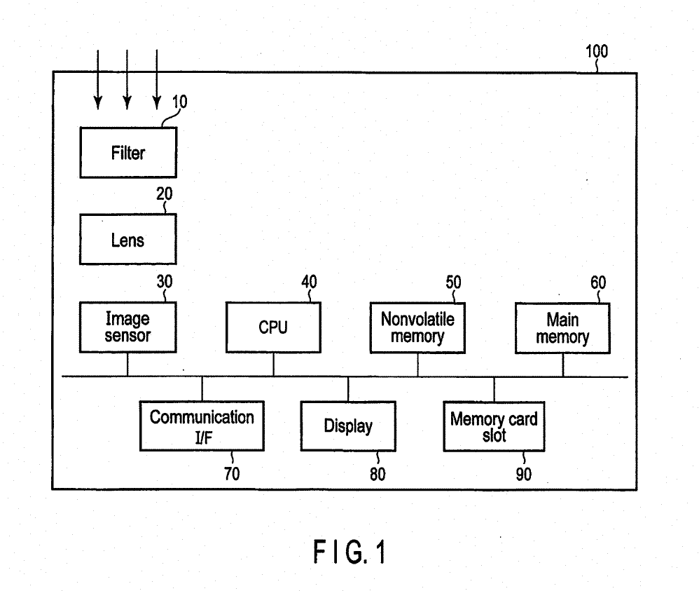

FIG. 1 is a block diagram showing an example of a hardware configuration of an imaging device according to this embodiment. The imaging device according to this embodiment can be realized as, for example, a camera, a mobile phone having a camera function, a portable information terminal such as a smart phone and a personal digital assistant or personal data assistant (PDA), a personal computer having a camera function, or an embedded system incorporated in various electronic apparatuses.

As shown in FIG. 1, an imaging device 100 includes a filter 10, a lens 20, an image sensor 30, an image processor, and a storage. The filter 10, the lens 20, and the image sensor 30 configure an imaging unit. The image processor is configured using a circuit such as a CPU 40, for example. The storage is configured using a nonvolatile memory 50 and a main memory 60, for example. The imaging device 100 may further include a communication I/F 70, a display 80, and a memory card slot 90. For example, the image sensor 30, the CPU 40, the nonvolatile memory 50, the main memory 60, the communication I/F 70, the display 80, and the memory card slot 90 can be mutually connected via a bus.

For example, the filter 10 is provided in an aperture of the imaging device 100 and transmits light (light reflected on a subject) incident to capture an image of the subject represented by an arrow in FIG. 1.

When the filter 10 is provided in the aperture of the imaging device 100, the lens 20 condenses the light having transmitted the filter 10.

The light having transmitted the filter 10 and the lens 20 reaches the image sensor 30 and is received by the image sensor 30. The image sensor 30 converts (photoelectrically converts) the received light into an electric signal, thereby generating an image including a plurality of pixels. In the following description, the image generated by the image sensor 30 is referred to as an captured image for the sake of convenience.

The image sensor 30 is realized by a charge coupled device (CCD) image sensor, a complementary metal oxide semiconductor (CMOS) image sensor, or the like, for example. For example, the image sensor 30 has a sensor (R sensor) to detect light of a red (R) wavelength region, a sensor (G sensor) to detect light of a green (G) wavelength region, and a sensor (B sensor) to detect light of a blue (B) wavelength region and receives the light of the corresponding wavelength regions by the individual sensors and generates images (an R image, a G image, and a B image) corresponding to the individual wavelength regions (color components). That is, the captured image includes the R image, the G image, and the B image.

The CPU 40 is a hardware processor that generally controls an operation of the imaging device 100. Specifically, the CPU 40 executes various programs (software) loaded from the nonvolatile memory 50 into the main memory 60. As the nonvolatile memory 50, for example, a rewritable storage device such as a hard disk drive (HDD) and NAND-type flash memory can be used. In addition, as the main memory 60, for example, a random access memory (RAM) or the like is used.

The communication I/F 70 is, for example, an interface that controls communication with an external apparatus. The display 80 includes a liquid crystal display, a touch screen display, and the like. The memory card slot 90 is configured so that a portable storage medium such as an SD memory card and an SDHC memory card can be inserted for use. When the storage medium is inserted into the memory card slot 90, writing and reading of data to and from the storage medium can be executed.

The image processor and the storage configure a processing device. The communication I/F 70, the display 80, and the memory card slot 90 may be included in the processing device.

In addition, the filter 10, the lens 20, the image sensor 30, the image processor, and the storage may configure a processing system. A part configuring the processing system may be connected to other parts by wireless communication. The communication I/F 70, the display 80, and the memory card slot 90 may be included in the processing system.

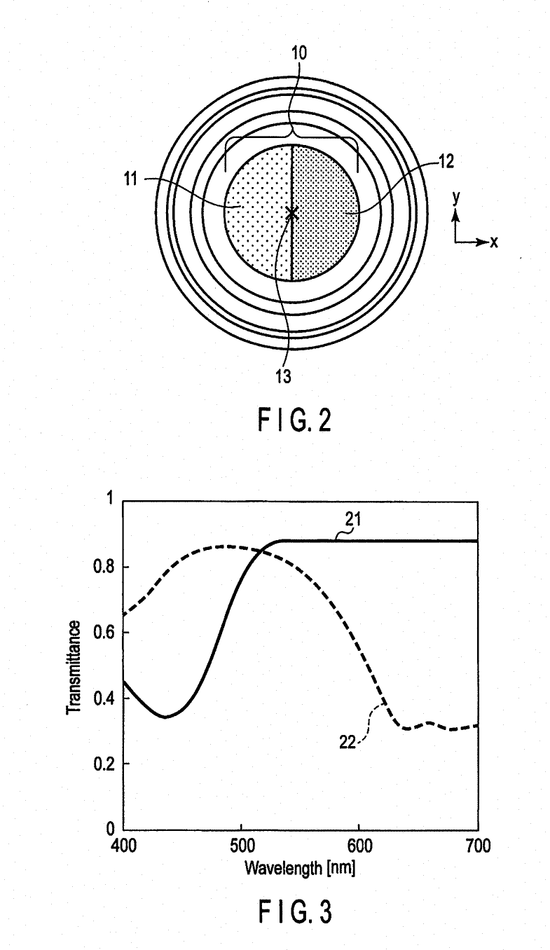

Next, an example of the filter 10 will be described with reference to FIG. 2. The filter 10 is a color filter and transmits light of a specific wavelength band. In the example shown in FIG. 2, the filter 10 includes a first filter region 11 and a second filter region 12.

A center of the filter 10 is matched with an optical center 13 of the imaging device 100. Each of the first filter region 11 and the second filter region 12 has a non-point symmetrical shape with respect to the optical center 13. The first filter region 11 and the second filter region 12 do not overlap each other and configure an entire region of the filter 10.

In the example shown in FIG. 2, each of the first filter region 11 and the second filter region 12 has a semicircular shape obtained by dividing the circular filter 10 by a line segment passing through the optical center 13. In addition, the first filter region 11 is, for example, a yellow (Y) filter region and the second filter region 12 is, for example, a cyan (C) filter region. In this case, the first filter region 11 transmits the light of the red wavelength region and the light of the green wavelength region and does not transmit the light of the blue wavelength region. In addition, the second filter region 12 transmits the light of the green wavelength region and the light of the blue wavelength region and does not transmit the light of the red wavelength region.

As described above, the filter 10 has the two or more color filter regions. Each of the color filter regions has a non-point symmetrical shape with respect the optical center of the imaging device 100. A part of the wavelength region of the light transmitting one of the color filter regions and a part of the wavelength region of the light transmitting other color filter region overlap each other, for example. The wavelength region of the light transmitting one of the color filter regions may include the wavelength region of the light transmitting other color filter region, for example.

Each of the first filter region 11 and the second filter region 12 may be a filter to change transmittance of any wavelength region, a polarization filter to pass polarized light of any direction, or a microlens to change condensing power of any wavelength region.

Hereinafter, the case where the first filter region 11 shown in FIG. 2 is a yellow (Y) filter region and the second filter region 12 is a cyan (C) filter region will mainly be described.

Here, FIG. 3 shows an example of transmittance characteristics of the first filter region 11 and the second filter region 12. In FIG. 3, transmittance for light of a wavelength longer than 700 nm in a wavelength region of visible light is not shown.

However, the transmittance is close to that in the case of 700 nm. As shown by a transmittance characteristic 21 of the yellow first filter region 11 shown in FIG. 3, by the first filter region 11, light of a red wavelength region of about 620 nm to 750 nm and light of a green wavelength region of about 495 nm to 570 nm are transmitted with high transmittance and light of a blue wavelength region of about 450 nm to 495 nm is rarely transmitted. In addition, as shown by a transmittance characteristic 22 of the cyan second filter region 12, by the second filter region 12, light of blue and green wavelength regions is transmitted with high transmittance and light of a red wavelength region is rarely transmitted.

Therefore, red light transmits only the yellow first filter region 11 and blue light transmits only the cyan second filter region 12. In addition, green light transmits both the first filter region 11 and the second filter region 12.

In this embodiment, “transmitting” means that light of a corresponding wavelength region is transmitted with high transmittance and attenuation (that is, reduction in an amount of light) of the light of the wavelength region is extremely small. That is, it is assumed that “transmitting” includes not only the case of transmitting all of the light of the corresponding wavelength region but also the case of transmitting the wavelength region mainly.

In addition, “not transmitting” means that the light of the corresponding wavelength region is shielded, for example, the light of the wavelength region is transmitted with low transmittance and attenuation of the light of the wavelength region by the filter region is extremely large. That is, it is assumed that “not transmitting” includes not only the case of not transmitting all of the light of the corresponding wavelength region but also the case of not transmitting the wavelength region mainly.

Specifically, although the first filter region 11 is configured to transmit the light of the red and green wavelength regions and not to transmit the light of the blue wavelength region, the first filter region 11 may not transmit all of the light of the red and green wavelength regions and may transmit a part of the light of the blue wavelength region. Likewise, although the second filter region 12 is configured to transmit light of the green and blue wavelength regions and not to transmit the light of the red wavelength region, the second filter region 12 may not transmit all of the light of the green and blue wavelength regions and may transmit a part of the light of the red wavelength region. In other words, according to the transmittance characteristics of the first filter region 11, and the second filter region 12, for example, the light of the first wavelength region transmits the first filter region 11 and does not transmit the second filter region 12, the light of the second wavelength region does not transmit the first filter region 11 and transmits the second filter region 12, and the light of the third wavelength region transmits both the first filter region 11 and the second filter region 12.

The imaging device 100 according to this embodiment can acquire information (hereinafter, referred to as distance information) showing a distance (depth) from the imaging device 100 to any subject, based on an image obtained by capturing image of the subject via the filter 10.

Here, when the imaging device 100 is used as a monitoring camera, for example, in the imaging device 100, it is required to detect that a suspicious person has intruded into a range (hereinafter, referred to as an imaging range) where an image is captured by the imaging device 100. In this case, distance information acquired from an image (hereinafter, referred to as a reference image) captured when an object such as the suspicious person does not exist and distance information acquired from an image (hereinafter, referred to as a target image) captured to detect the presence or absence of an object of a detection target such as the suspicious person are compared, so that it can be detected whether or not the object such as the suspicious person exists in the imaging range.

However, in this case, the distance information needs to be calculated from each of the reference image and the target image and a calculation cost is high. In the monitoring camera, the target image is captured every moment and it is necessary to detect the presence or absence of an object (for example, an intruder) in real time, in many cases. Therefore, because a cost of calculating the distance information from the target image captured every moment is high, this is not preferable.

On the other hand, because the imaging device 100 according to this embodiment calculates an evaluation value regarding the presence or absence of the object in the imaging range, a calculation cost for detecting the presence or absence of the object can be reduced.

In this embodiment, a detection target object is an object not existing in the reference image or an object moved from when the reference image is captured. Also, the detection target object may be a person, an animal, or a vehicle such as a car.

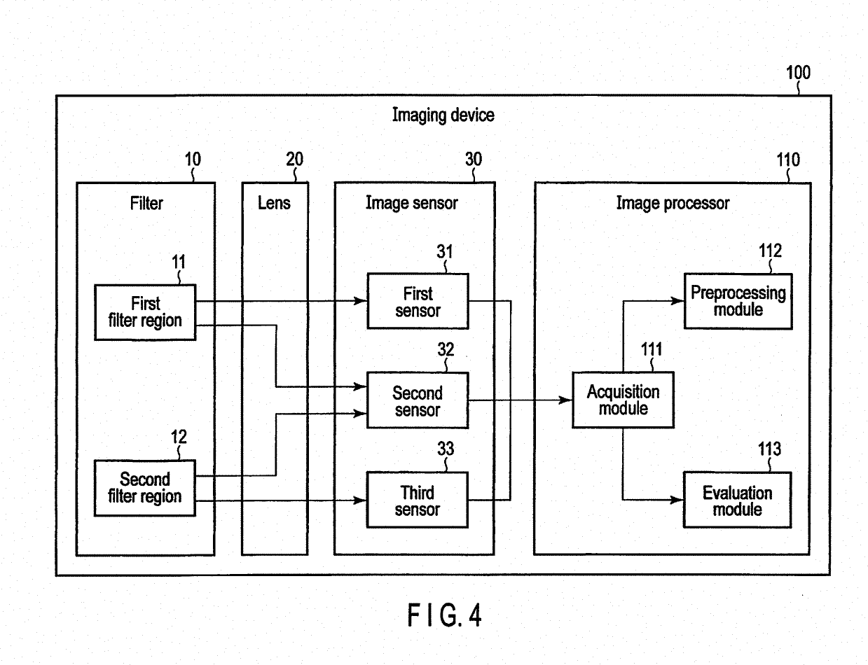

FIG. 4 shows an example of a functional configuration of the imaging device 100 according to this embodiment. As shown in FIG. 4, the imaging device 100 includes an image processor 110 as a functional configuration module, in addition to the filter 10, the lens 20, and the image sensor 30 described above. In this embodiment, it is assumed that a part or all of the image processor 110 is realized by causing a computer such as the CPU 40 to execute a program, that is, by software. The program executed by the computer may be stored in a computer readable storage medium and distributed and may be downloaded to the imaging device 100 through a network. A part or all of the image processor 110 may be realized by hardware such as an integrated circuit (IC) and may be realized as a combination of software and hardware.

The image sensor 30 photoelectrically converts the light having transmitted the filter 10 and the lens 20 and sends an electric signal to the image processor 110. In FIG. 4, a configuration where the lens 20 is provided between the filter 10 and the image sensor 30 is shown. However, the filter 10 may be provided between the lens 20 and the image sensor 30 and when there are a plurality of lenses 20, the filter 10 may be provided between the two lenses. In addition, the filter 10 may be provided in the lens 20 and may be provided on a plane of the lens 20. That is, the filter 10 may be provided at a position where the image sensor 30 can receive the light having transmitted the filter 10 to generate an image.

The image sensor 30 includes a first sensor 31, a second sensor 32, and a third sensor 33. For example, the first sensor 31 is an R sensor to detect light of a red wavelength region (color component), the second sensor 32 is a G sensor to detect light of a green wavelength region (color component), and the third sensor 33 is a B sensor to detect light of a blue wavelength region (color component).

The first sensor 31 generates an R image based on the detected light of the red wavelength region. The second sensor 32 generates a G image based on the detected light of the green wavelength region. The third sensor 33 generates a B image based on the detected light of the blue wavelength region.

Here, because the second sensor 32 detects the light of the green wavelength region having transmitted both the first filter region 11 and the second filter region 12 as described above, the G image can become an image that is brighter and less noisy than the other images (the R image and the B image). In addition, it can be said that the G image is an image less affected by the provision of the filter 10. On the other hand, because the R image generated by the first sensor 31 and the B image generated by the third sensor 33 are images generated from light having transmitted one of the first filter region 11 and the second filter region 12, the R image and the B image are different from the G image. Details of the R image and the B image will be described later.

An captured image (image captured by the imaging device 100) including the R image, the G image, and the B image generated by the first sensor 31, the second sensor 32, and the third sensor 33 as described above is output from the image sensor 30 to the image processor 110.

The captured image output from the image sensor 30 to the image processor 110 includes the image (reference image) captured when the object does not exist and the image (target image) captured to detect the presence or absence of the object. At least parts of imaging ranges of the reference image and the target image overlap each other. For example, the imaging ranges of the reference image and the target image are the same.

As shown in FIG. 4, the image processor 110 includes an acquisition module 111, a preprocessing module 112, and an evaluation module 113.

The acquisition module 111 acquires the reference image and the target image. An object in the reference image is referred to as a background for the sake of convenience. In the reference image, only the background is shown. The background includes a wall surface, a floor surface, and an object not to be the detection target, for example. In the target image, only the background may be shown and the background and the detection target object may be shown.

The preprocessing module 112 calculates a distance (hereinafter, referred to as a background distance) from the imaging device 100 to the background, based on the R image, the G image, and the B image included in the reference image acquired by the acquisition module 111. For example, the preprocessing module 112 calculates a background distance for each of pixels of the reference image. Calculation processing of the background distance by the preprocessing module 112 will be described later.

The evaluation module 113 calculates an evaluation value regarding the presence or absence of the object in the imaging range, based on at least one of the R image, the G image, and the B image included in the target image acquired by the acquisition module 111 and the background distance calculated by the preprocessing module 112. Calculation processing of the evaluation value by the evaluation module 113 will be described later.

Next, processing executed by the imaging device 100 according to this embodiment will be described. The processing executed by the imaging device 100 according to the this embodiment includes preprocessing executed mainly by the preprocessing module 112 and evaluation processing executed mainly by the evaluation module 113.

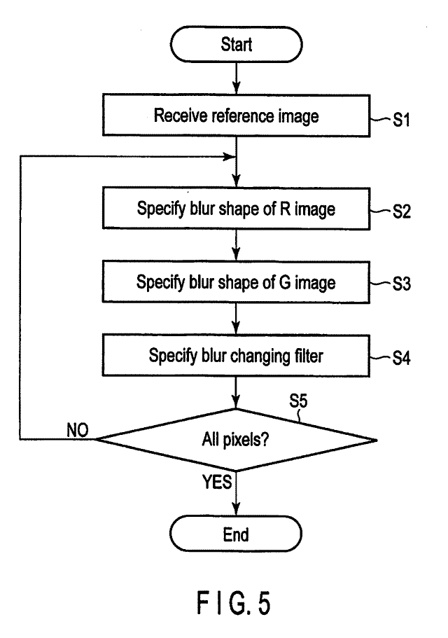

First, an example of a processing procedure of the preprocessing will be described with reference to a flowchart of FIG. 5. The preprocessing is processing executed on the reference image captured when the object does not exist.

In the preprocessing, the preprocessing module 112 receives the reference image from the acquisition module 111 (step S1). The reference image includes, for example, the R image, the G image, and the B image.

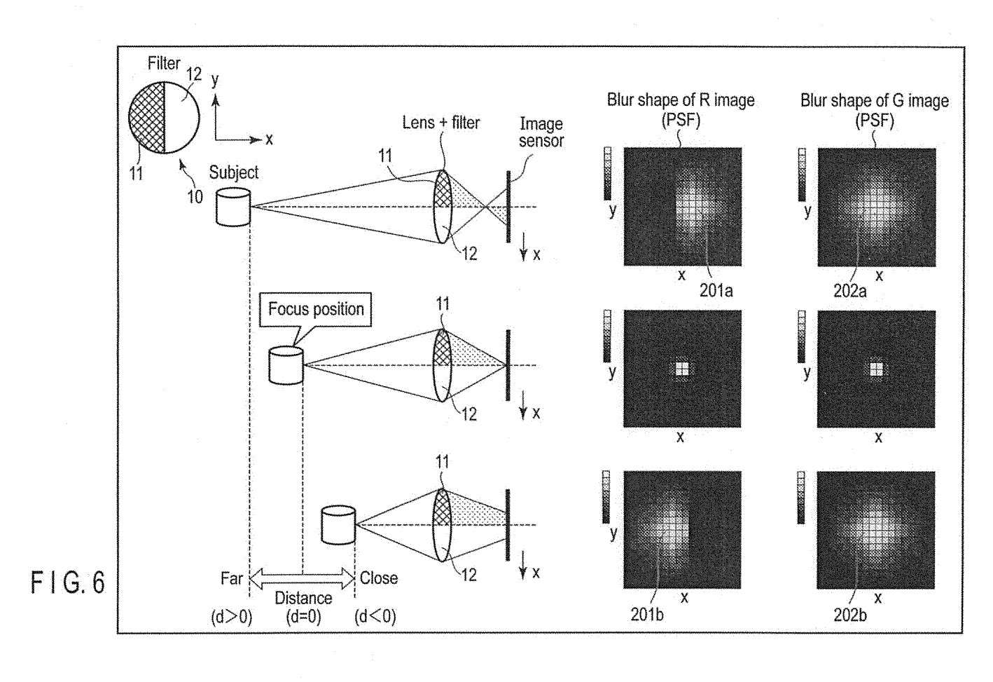

Here, the R image will be conceptually described with reference to FIG. 6. A right row and a middle row of FIG. 6 show blur shapes of a G image and an R image formed on the image sensor 30 when a point light source is imaged as a subject, respectively, and a left row shows a positional relation of a combination of the lens 20 and the filter 10, the image sensor 30, and the subject, when the imaging device 100 is viewed from an upward direction (that is, a positive direction of a Y axis parallel to a division direction of the filter 10).

In the following description, a distance from the position at which the imaging device 100 is in focus (hereinafter, referred to as a focus position) to the subject (background) is referred to as a distance d. It is assumed that the distance d becomes a positive value when a position of the subject is farther than the focus position with the focus position as a reference (0) and becomes a negative value when the position of the subject is closer than the focus position.

First, the case where the position of the subject is farther than the focus position, that is, the case of the distance d>0 is assumed. In this case, because the subject is out of focus, as shown in an upper step of FIG. 6, blurs occur in both the R image and the G image.

In addition, a shape (hereinafter, simply referred to as the blur shape) 201a of the blur of the R image in the case of the distance d>0 becomes an asymmetrical shape deviated to the right side as compared with a blur shape 202a of the point symmetrical G image. The reason why the blur shape 202a of the G image is the point symmetrical shape is that the first filter region 11 and the second filter region 12 of the filter 10 transmit the green (G) light substantially equally. The reason why the blur shape 201a of the R image is the non-point symmetrical shape (shape deviated to the right side) is that the first filter region 11 of the filter 10 transmits the red (R) light and the second filter region 12 does not transmit the red (R) light.

The blur shape described in this embodiment occurs in a predetermined subimage including a specific pixel. This is also applied to the following description.

A function representing the blur shape of the image obtained by imaging each of the point light sources such as the blur shapes 201a and 202a as the subject is referred to as a point spread function (PSF). Here, PSF is expressed as a blur function or a blur shape.

Next, the case where the position of the subject is matched with the focus position, that is, the case of the distance d=0 is assumed. As shown in a middle step of FIG. 6, no blur occurs in both the R image and the G image in this case.

In addition, the case where the position of the subject is closer than the focus position, that is, the case of the distance d<0 is assumed. In this case, as shown in a lower step of FIG. 6, because the subject is out of focus, blurs occur in both the R image and the G image.

As described above, although the R image is an image generated based on the light mainly having transmitted the first filter region 11, a blur shape 201b of the R image in the case of the distance d<0 becomes a shape deviated to the left side as compared with a blur shape 202b of the G image, as shown in the lower step of FIG. 6.

In other words, similar to the blur shape 201a, the blur shape 201b is a non-point symmetrical shape and the blur shape 201b becomes a shape obtained by inverting the blur shape 201a with a straight line parallel to a Y-axis direction as an axis.

On the other hand, the blur shape 202b of the G image in this case becomes a point symmetrical shape, similar to the blur shape 202a of the G image.

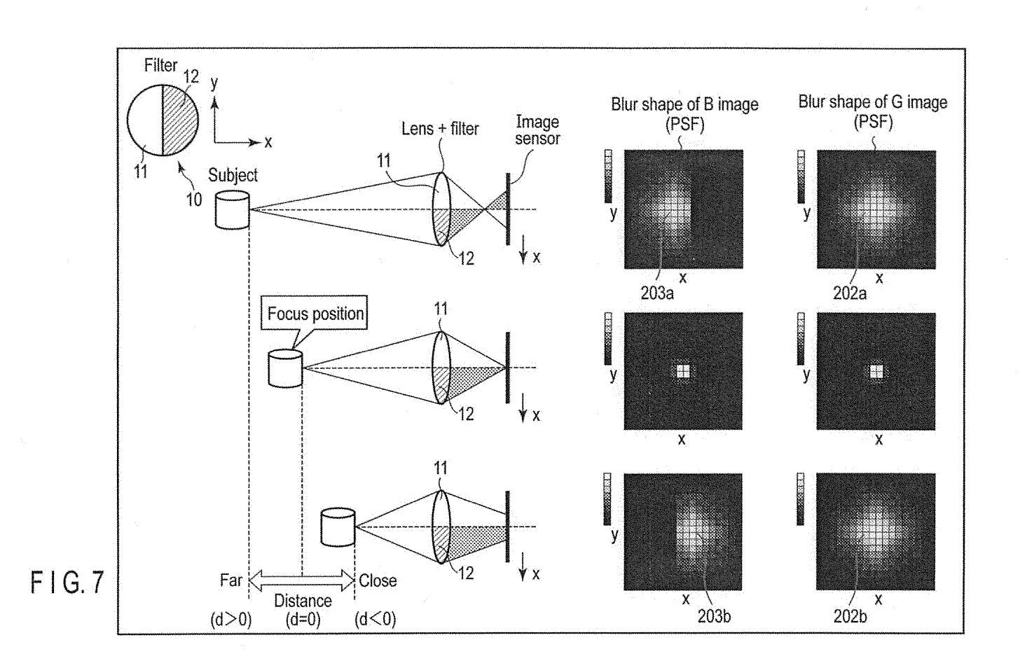

Next, the B image will be conceptually described with reference to FIG. 7. A right row and a middle row of FIG. 7 show blur shapes of the G image and the B image formed on the image sensor 30 when the point light source is imaged as the subject, respectively, and a left row shows a positional relation of a combination of the lens 20 and the filter 10, the image sensor 30, and the subject when the imaging device 100 is viewed from an upward direction (that is, a positive direction of the Y axis). Because the blur shape of the G image shown in FIG. 7 is as described in FIG. 6, the detailed description thereof will be omitted.

First, the case where the position of the subject is farther than the focus position, that is, the case of the distance d>0 is assumed. In this case, because the subject is out of focus, as shown in an upper step of FIG. 7, blurs occur in both the B image and the G image.

In addition, as described above, the B image is an image generated based on the light mainly having transmitted the second filter region 12. Therefore, a blur shape 203a of the B image in the case of the distance d>0 becomes an asymmetrical shape deviated to the left side as compared with a blur shape 202a of the point symmetrical G image. The reason why the blur shape 203a of the B image is the non-point symmetrical shape (shape deviated to the left side) is that the yellow (Y) first filter region 11 of the filter 10 rarely transmits the blue (B) light and the cyan (C) second filter region 12 transmits the blue (B) light.

Next, the case where the position of the subject is matched with the focus position, that is, the case of the distance d=0 is assumed. As shown in a middle step of FIG. 7, no blur occurs in both the B image and the G image in this case.

In addition, the case where the position of the subject is closer than the focus position, that is, the case of the distance d<0 is assumed. In this case, as shown in a lower step of FIG. 7, because the subject is out of focus, blurs occur in both the B image and the G image.

In addition, a blur shape 203b of the B image in the case of the distance d<0 becomes a shape deviated to the right side as compared with a blur shape 202b of the G image, as shown in the lower step of FIG. 7.

In other words, similar to the blur shape 203a, the blur shape 203b is a non-point symmetrical shape and the blur shape 203b becomes a shape obtained by inverting the blur shape 203a with a straight line parallel to the Y-axis direction as an axis.

As described above, in the R image and the B image, the blur shape changes according to the distance d. Specifically, the blur shape of the R image changes to a semicircular shape (non-point symmetrical shape) where the left side of the blur shape of the G image is missing in the case of the distance d>0 and changes to a semicircular shape (non-point symmetrical shape) where the right side of the blur shape of the G image is missing in the case of the distance d<0. On the other hand, the blur shape of the B image changes to a semicircular shape (non-point symmetrical shape) where the right side of the blur shape of the G image is missing in the case of the distance d>0 and changes to a semicircular shape (non-point symmetrical shape) where the left side of the blur shape of the G image is missing in the case of the distance d<0. That is, the blur shape of the R image becomes a shape obtained by inverting the blur shape of the B image with the straight line parallel to the Y-axis direction as the axis.

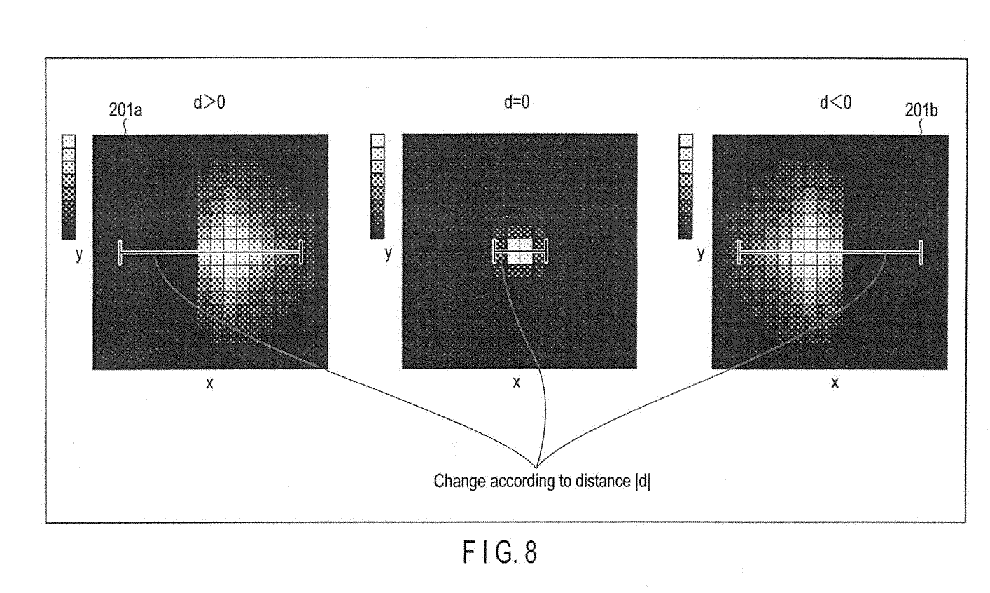

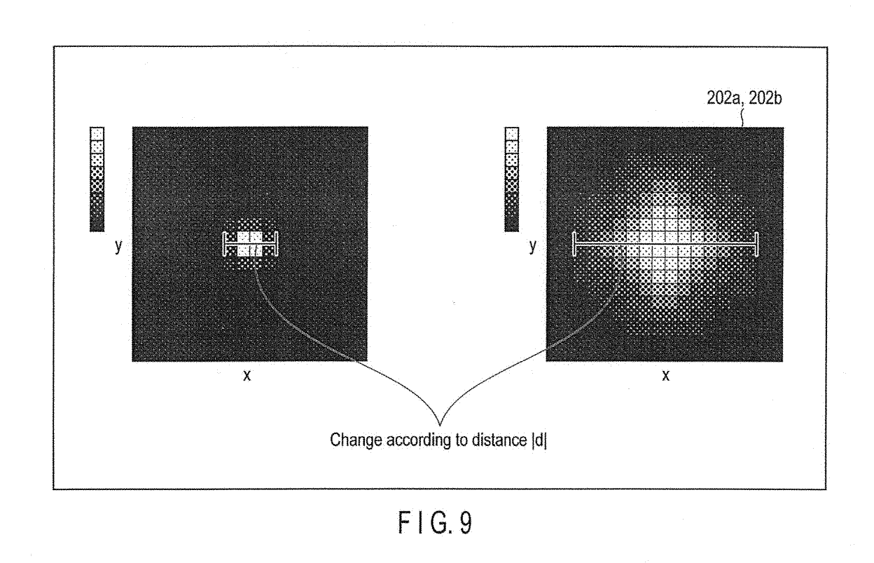

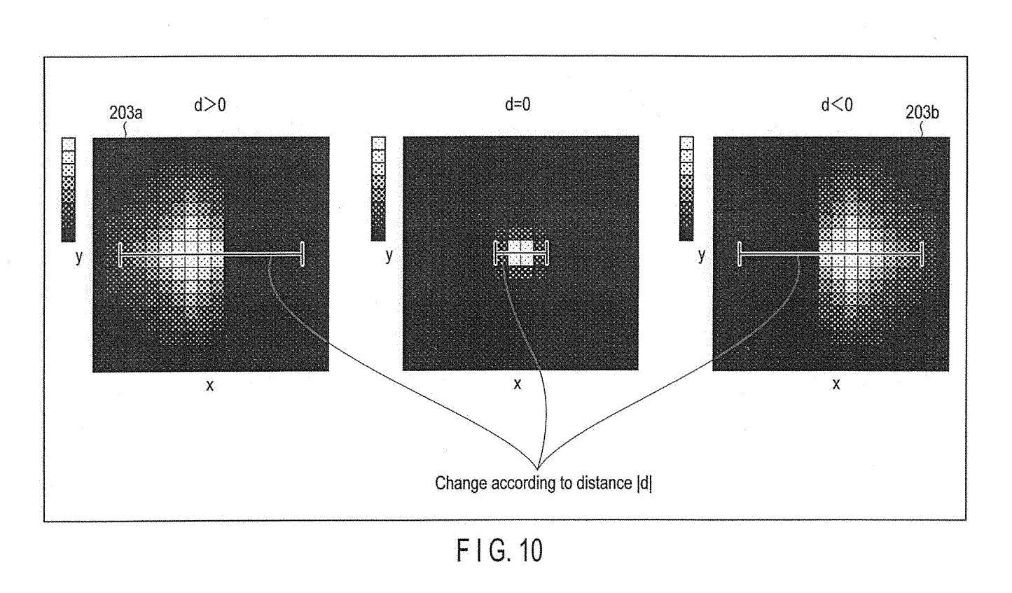

Although not shown in FIGS. 6 and 7, sizes (widths) of the blur shapes in the R image, the G image, and the B image depend on a distance |d|. FIG. 8 shows that the size of the blur shape of the R image changes according to the distance |d|. FIG. 9 shows that the size of the blur shape of the G image changes according to the distance |d|. FIG. 10 shows that the size of the blur shape of the B image changes according to the distance |d|. That is, the size of the blur shape increases (the width increases) when the distance |d| increases.

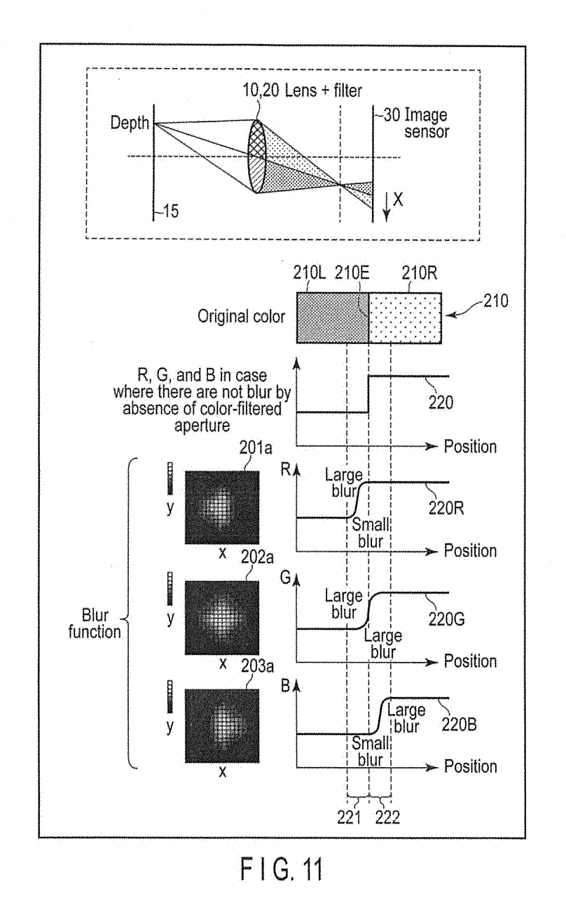

The blur shape mainly appears in an edge region (edge portion) in the image. Hereinafter, the blur shape in the edge region in the image will be described with reference to FIG. 11.

In FIG. 11, pixels in the edge region 210 to be a boundary between a dark region (for example, a black region) and a light region (for example, a white region) in the image will be described. Here, the case where the distance d from the imaging device 100 (image sensor 30) to the subject (background) 15 included in the image is farther than the focus position (that is, the case of the distance d>0) is assumed.

Here, it is assumed that the edge region 210 includes a left dark region 210L and a right light region 210R. A boundary between the dark region 210L and the light region 210R is an edge 210E. If the filter 10 is not disposed, focusing is performed, and there is no blur, a relation 220 between pixel positions and pixel values in the regions 210L and 210R in each of the R image, the G image, and the B image becomes a sharp edge shape.

However, in actuality, because the edge region 210 is affected by the filter 10 and is out of focus, the edge region 210 includes a blur.

For example, the blur function of the R image of the subject at the distance d is a blur function 201a. In the R image of the subject at the distance d, a non-point symmetrical blur deviated to the left side occurs. As can be seen from a result of convoluting the blur function 201a to the pixel values in the regions 210L and 210R, according to a relation 220R between the pixel positions and the pixel values in the edge region 210 on the R image, a large blur occurs in a first region 221 of the left side of the edge 210E and a small blur occurs in a second region 222 of the right side thereof.

The blur function of the G image of the subject at the distance d is a blur function 202a. A point symmetrical blur occurs in the G image of the subject at the distance d. As can be seen from a result of convoluting the blur function 202a to the pixel values in the regions 210L and 210R, according to a relation 220G between the pixel positions and the pixel values in the edge region 210 on the G image, large blurs occur in both the first region 221 of the left side of the edge 210E and the second region 222 of the right side thereof.

The blur function of the B image of the subject at the distance d is a blur function 203a. In the B image of the subject at the distance d, a non-point symmetrical blur deviated to the right side occurs. As can be seen from a result of convoluting the blur function 203a to the pixel values in the regions 210L and 210R, according to a relation 220B between the pixel positions and the pixel values in the edge region 210 on the B image, a small blur occurs in the first region 221 of the left side of the edge 210E and a large blur occurs in the second region 222 of the right side thereof.

As described above, in the edge regions of the images captured in the imaging device 100 according to this embodiment, the blur shapes corresponding to the R, G, and B images are observed. In other words, according to the imaging device 100, images including a color component having a symmetrical blur function and a color component having an asymmetrical blur function can be generated.

Returning to FIG. 5 again, the preprocessing module 112 executes processing of the following steps S2 to S4 for each of the pixels configuring the reference images (the R image and the G image). Hereinafter, pixels targeted in the processing of steps S2 to S4 are referred to as target pixels.

The preprocessing module 112 acquires a pixel value of a predetermined subimage including the target pixel in the R image included in the reference image acquired in step S1 (step S2).

In addition, the preprocessing module 112 acquires a pixel value of a predetermined subimage including the target pixel in the G image included in the reference image acquired in step S1 (step S3).

Steps S2 and S3 may be performed in reversed order or simultaneously. In step S2, the B image may be used in place of the R image.

Each of a plurality of blur changing filters corresponding to a plurality of prepared distances d is applied to the predetermined subimage of the R image acquired in step S2 and a blur changing filter in which an application result is closest to the predetermined subimage of the G image acquired in step S3 is specified (step S4).

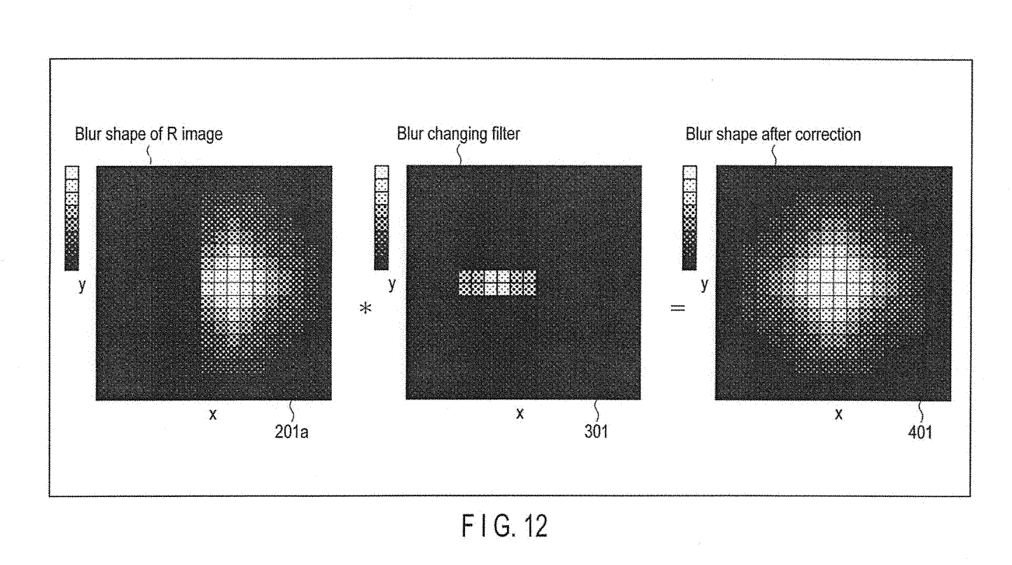

The case where the blur changing filter is applied to the blur shape of the R image obtained by imaging the point light source as the subject, that is, the blur function in step S4 will be described with reference to FIG. 12. Here, as shown in FIG. 12, the blur function 201a of the R image in the case of the distance d>0 will be described.

A blur changing filter 301 shown in FIG. 12 corresponds to a blur function in which a blur is distributed on a straight line (in the vicinity of the straight line) of a negative direction of an X axis passing through a center point of a line dividing the first filter region 11 and the second filter region 12 and perpendicular to the line.

When the blur changing filter 301 is applied to the blur shape 201a of the R image, as shown in FIG. 12, the blur shape 201a of the R image is changed to a blur shape 401.

In FIG. 12, although only one blur changing filter has been described, in this embodiment, as described above, the blur changing filters corresponding to the different distances d are prepared as described above.

The distance d corresponding to the blur changing filter specified in step S4 corresponds to the distance (background distance) from the imaging device 100 to the background (for example, a wall surface or the like) existing in the region including the target pixel.

Here, the blur changing filters corresponding to the different distances d will be conceptually described with reference to FIGS. 13 to 16 while using the case where the point light source is imaged as the subject as an example.

As shown in FIG. 13, the predetermined subimages including the target pixels in the R and G images are matched with the blur functions 201a and 202a. Therefore, in this example, the predetermined subimages including the target pixels in the R and G images are expressed as the blur functions 201a and 202a or the blur shapes 201a and 202a.

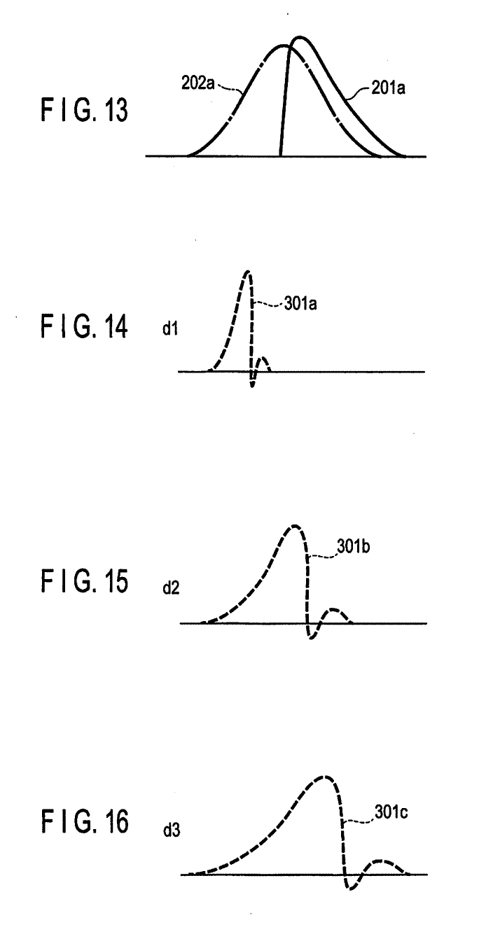

FIG. 14 shows a blur changing filter 301a corresponding to a distance d1, for example. FIG. 15 shows a blur changing filter 301b corresponding to a distance d2, for example. FIG. 16 shows a blur changing filter 301c corresponding to a distance d3, for example. The blur changing filters 301a to 301c are prepared as blur changing filters applied to the blur shape 201a of the R image. It is assumed that the distances d1, d2, and d3 are in a relation of d1<d2<d3.

In this case, three changed blur functions are obtained by applying, that is, convoluting the blur changing filters 301a to 301c of FIGS. 14, 15, and 16 to the blur function 201a of the R image shown in FIG. 13. It is determined which of these three changed blur functions is closest to the blur function 202a of the G image. An error or a correlation is used when closeness is evaluated. When a value of the error is smaller, it means higher closeness. When a value of the correlation is larger, it means higher closeness. As an error evaluation method, for example, sum of squared difference (SSD), sum of absolute difference (SAD), Color Alignment Measure, or the like is used. As a correlation evaluation method, for example, normalized cross-correlation (NCC), zero-mean normalized cross-correlation (ZNCC), or the like is used.

For example, even if the blur changing filter 301a of FIG. 14 is applied to the blur shape 201a of FIG. 13, a changed blur shape is not close to the blur shape 202a of the G image.

For example, when the blur changing filter 301b of FIG. 15 is applied to the blur shape 201a of FIG. 13, a changed blur shape is close to the blur shape 202a of the G image.

For example, even if the blur changing filter 301c of FIG. 16 is applied to the blur shape 201a of FIG. 13, a changed blur shape is not close to the blur shape 202a of the G image.

According to this, in step S4 shown in FIG. 5, the blur changing filter 301b is specified. In other words, the distance d2 corresponding to the blur changing filter 301b is specified as the distance from the imaging device 100 to the subject existing in the region including the target pixel.

By executing the processing described above, the preprocessing module 112 can calculate the distance d from the imaging device 100 to the background (background existing in the region including the target pixel).

By executing the processing described above, it is possible to specify the blur changing filter (that is, the blur changing filter corresponding to the target pixel) to approximate the blur function of the target pixel of the R image to the blur function of the target pixel of the G image. In other words, a blur shape of an image (fourth image) obtained by applying the blur changing filter specified here to the R image (first color component image) of the reference image becomes closer to the blur shape of the G image (third color component image) of the reference image than the blur shape of the R image. Information showing the blur changing filter corresponding to the target pixel is held in the image processor 110, for example.

Returning to FIG. 5 again, when the processing of step S4 is executed, it is determined whether or not the processing of steps S2 to S4 has been executed for all the pixels (step S5).

When it is determined that the processing is not executed for all the pixels (NO in step S5), the procedure returns to step S2 and the processing is repeated. In this case, the processing is repeated with the pixel for which the processing of steps S2 to S4 is not executed (that is, the blur changing filter is not specified) as the target pixel.

On the other hand, when it is determined that the processing has been executed for all the pixels (YES in step S5), the preprocessing shown in FIG. 5 ends. As such, if the preprocessing ends, the information showing the blur changing filter corresponding to each of the pixels configuring the R image is held in the image processor 110.

In step S5, instead of determining whether or not the processing has been executed for all the pixels, it may be determined whether or not the processing has been executed for a part of the image. A part of the image includes the region including the target pixel used in steps S2 and S3, for example.

The preprocessing shown in FIG. 5 may be executed regularly (that is, the reference image is captured regularly) or may be executed according to an environmental change in the imaging range (for example, a position where the imaging device 100 is installed is changed).

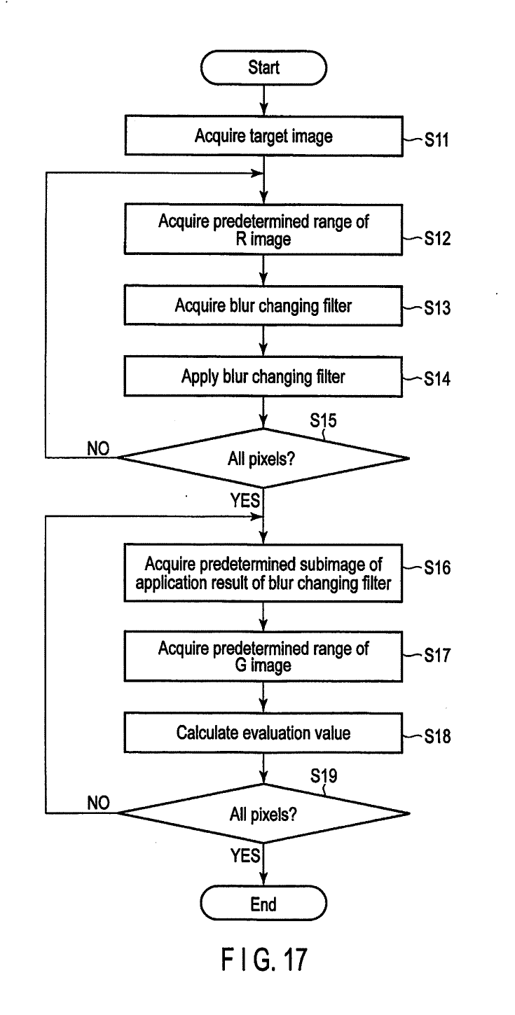

Next, an example of a processing procedure of the evaluation processing will be described with reference to a flowchart of FIG. 17. The evaluation processing is processing executed on a target image captured to detect the presence or absence of an object.

In the evaluation processing, the acquisition module 111 acquires the target image output by the image sensor 30 (step S11). The target image acquired in step S11 includes the R image, the G image, and the B image and is stored in the storage.

Next, the evaluation module 113 executes processing of the following steps S12 to S15 and S16 to S19 for each of the pixels configuring the target image (R image). Hereinafter, a pixel targeted in the processing of steps S12 to S15 and S16 to S19 is referred to as a target pixel.

Because the processing shown in FIG. 5 is executed on the R image (and the G image) as described above, the processing is executed on the R image here. However, a wavelength range of a color component (second color component) of the image to be processed may overlap at least a part of a wavelength range of a color component (first color component) of the image on which the processing shown in FIG. 5 has been executed.

The evaluation module 113 acquires a predetermined subimage including the target pixel in the R image included in the target image acquired in step S11 (step S12).

The evaluation module 113 acquires a blur changing filter corresponding to the target pixel, based on the information (information showing the blur changing filter corresponding to each pixel) held in the image processor 110 in the preprocessing described above (step S13).

The evaluation module 113 convolutes (applies) the blur changing filter acquired in step S13 to the predetermined subimage of the R image acquired in step S12 (step S14). Because application processing of the blur changing filter is as described above, the detailed description thereof will be omitted.

When it is determined that the processing is not executed for all the pixels (NO in step S15), the procedure returns to step S12 and the processing is repeated. In this case, the processing is repeated with the pixel for which the processing of steps S12 to S14 is not executed as the target pixel. On the other hand, when it is determined that the processing has been executed for all the pixels (YES in step S15), the procedure proceeds to step S16. In this case, an image obtained as a result of applying the blur changing filters to all the pixels of the R image is generated. The image obtained as the result of applying the blur changing filters is stored in the storage. The image obtained as the result of applying the blur changing filters is an image (third image) obtained by applying the blur changing filter (that is, the blur changing filter acquired in step S13) for changing the blur shape of the R image (first color component image) included in the reference image (first image) to the R image (second color component image) included in the target image (second image).

The evaluation module 113 acquires a predetermined subimage including the target pixel in the image obtained as the result of applying the blur changing filters to all the pixels of the R image (step S16). The predetermined subimage may be only the target pixel or may be a plurality of pixels including the target pixel.

The evaluation module 113 acquires a predetermined subimage including the target pixel in the G image of the target image (step S17). Here, the predetermined subimage is the same subimage as step S16.

The evaluation module 113 calculates an evaluation value based on the predetermined subimage acquired in step S16 and the predetermined subimage acquired in step S17 (step S18). The evaluation value shown in step S18 is a value showing whether or not an object not existing in the reference image or an object existing at position different from a position of the reference image exists in the target image.

When it is determined that the processing is not executed for all the pixels (NO in step S19), the procedure returns to step S16 and the processing is repeated. In this case, the processing is repeated with the pixel on which the processing of steps S16 to S18 is not executed as the target pixel. On the other hand, when it is determined that the processing has been executed for all the pixels (YES in step S19), the evaluation processing ends. As such, if the evaluation processing ends, the evaluation value is calculated for each of the pixels configuring the target image.

In steps S15 and S19, instead of determining whether or not the processing has been executed for all the pixels, it may be determined whether or not the processing has been executed for a partial region of the image. For example, a part of the image includes the predetermined subimage used in step S12. The partial region of the image on which the processing is executed may be designated by a user and may be designated by other method.

When a detection target object does not exist in the target image acquired in step S11, the R image and the G image included in the target image become images substantially equal to the R image and G image included in the reference image. In this case, the predetermined subimage of the image to be the application result of the blur changing filter, which is acquired in step S16, becomes close to the predetermined subimage of the G image acquired in step S17.

On the other hand, when the detection target object exists in the target image acquired in step S11, the distance calculated for the target pixel in the reference image is different from the distance calculated for the target pixel in the target image, in many cases. In this case, the predetermined subimage of the application result of the blur changing filter acquired in step S16 is not close to the predetermined subimage of the G image acquired in step S17, in many cases.

As the evaluation value calculated in step S18, an evaluation value of closeness of the predetermined subimage of the application result of the blur changing filter acquired in step S16 and the predetermined subimage of the G image acquired in step S17 is used. Specifically, the error or the correlation described above is used. The evaluation is also referred to as an evaluation value of a depth change.

Here, the case where the G image of the target image is acquired in step S17 and is used for calculation of the evaluation value in step S18 has been described. However, the G image of the reference image may be acquired and used for the calculation of the evaluation value in step S18. Even in this case, the evaluation value can be calculated in the same way.

It can be detected that the detection target object exists in the pixel in which the calculated evaluation value shows that the predetermined subimage of the application result of the blur changing filter acquired in step S16 and the predetermined subimage of the G image acquired in step S17 are not close to each other. Specifically, when the evaluation value is the error, it can be determined that the detection target object exists in the pixel for which an evaluation value larger than a predetermined value (hereinafter, referred to as a threshold value) among the evaluation values calculated for each of the pixels configuring the target image is calculated. When the evaluation value is the correlation, it can be determined that the detection target object exists in the pixel for which an evaluation value equal to or smaller than the threshold value is calculated. When it is determined that the detection target object exists, a subimage in the target image where the object exists may be detected (specified).

For example, the evaluation processing may be executed in the evaluation module 113 in the imaging device 100 or may be executed in an apparatus outside the imaging device 100. A detection result (whether or not the detection target object exists) may be used to control other apparatus. In addition, the threshold value used in the evaluation processing may be appropriately changed (set) according to a control target apparatus.

In the processing shown in FIGS. 5 and 17, the blur changing filter for approximating the predetermined subimage of the R image in the reference image to the predetermined subimage of the G image in the reference image is specified in the preprocessing and the evaluation value regarding the presence or absence of the detection target object is calculated by comparing the result of applying the blur changing filter to the predetermined subimage of the R image in the target image and the predetermined subimage of the G image in the target image in the evaluation processing.

In this embodiment, an example of the case where the blur changing filter approximates the blur function of the R image to the blur function of the G image has been described. However, conversely, a blur changing filter to approximate the blur function of the G image to the blur function of the R image may be prepared. In this case, the blur changing filter needs to be applied to the predetermined subimage of the G image, not the predetermined subimage of the R image. In addition, the evaluation value needs to be calculated from the result of the blur changing filter for the G image and the predetermined subimage of the R image. The blur changing filter can be calculated based on images of at least two color components. The blur function of the image of at least one of the two color components is non-point symmetric, for example. The other may be point symmetric or may be non-point symmetric.

In this embodiment, an example of the case where the evaluation value is calculated from the R and G images has been described. However, the evaluation value may be calculated from the G and B images. In this case, it is necessary to change the image to be acquired and the blur changing filter accordingly. The blur changing filter may approximate the blur function of the B image to the blur function of the G image or may approximate the blur function of the G image to the blur function of the B image. In addition, the evaluation value may be calculated from the R and B images. In this case, it is necessary to change the image to be acquired and the blur changing filter accordingly. The blur changing filter may approximate the blur function of the R image to the blur function of the B image or may approximate the blur function of the B image to the blur function of the R image. That is, the evaluation value can be calculated based on images of at least two color components. The color component of the image used for calculating the evaluation value and the color component of the image used for calculating the blur changing filter may not be the same.

In this embodiment, an example of the case where the blur changing filter approximates the blur function of the R image to the blur function of the G image has been described. However, a blur changing filter that approximates the blur function of the R image to a predetermined blur function changing according to the distance and a blur changing filter that approximates the blur function of the G image to a predetermined blur function changing according to the distance may be used. The predetermined blur function is, for example, the blur function of the B image, a blur function of an imaginary color component calculated by simulation, or a blur function of another color component when the filter 10 is changed to another filter. In this case, for example, the blur changing filters corresponding to the R and G images may be applied and the evaluation value may be calculated from respective application results.

In this embodiment, an example using the two color component images of the R and G images has been described. However, three color component images, that is, R, G, and B images may be used. In this case, the R, G, and B images are acquired and blur changing filters that approximate a blur function of the R image to a blur function of the G image, approximate the blur function of the G image to a blur function of the B image, and approximate the blur function of the B image to the blur function of the R image are prepared. As the evaluation value, an average value of an evaluation value calculated from a blur changing result for the R image and the G image, an evaluation value calculated from a blur changing result for the G image and the B image, and an evaluation value calculated from a blur changing result for the B image and the R image is used.

In this embodiment, the evaluation value can be calculated based on the blur changing filter corresponding to the background distance.

As described above, the blur function of the G image is point symmetric. Therefore, when the blur changing filter to approximate the blur function of the R image in the reference image to the blur function of the G image in the reference image is specified in the preprocessing, the evaluation value may be calculated based on whether or not a result of applying the blur changing filter to a predetermined subimage of the R image included in the target image has symmetry (point symmetry or line symmetry) in the evaluation processing. The same is also applied to the case where the blur changing filter to approximate the blur function of the B image to the blur function of the G image is specified in the preprocessing.

Here, although the calculation processing of the evaluation values has been described, at least one of the calculation processing may be executed. In addition, a part of the calculation processing of the evaluation values may be combined and executed.

In this embodiment, the case where the reference image is previously captured in a state in which the detection target object does not exist and the preprocessing is executed has been described. However, the reference image may be an image captured earlier than the target image, for example, an image one frame before the target image. Even in this case, the evaluation value (that is, the evaluation value of the change in the depth) regarding the presence or absence of the detection target object in the imaging range can be calculated.

As described above, in this embodiment, for example, the R image (image of the first color component) included in the target image is acquired and the evaluation value regarding the presence or absence of the detection target object in the imaging range is calculated based on the result of applying the blur changing filter corresponding to the distance (background distance) from the imaging device 100 to the background in the target image to the R image.

In this embodiment, by this configuration, when the presence or absence of the detection target object is detected from the target image, it is unnecessary to execute the processing of calculating the distance information based on the target image. Therefore, a calculation cost can be reduced.

The imaging device 100 according to this embodiment operates as a type of distance sensor capable of calculating the background distance based on the R image and the G image or the B image included in the reference image as described above. However, the background distance may be acquired from other distance sensors (depth sensors) or design data of an object existing in the imaging range (background), for example. Other distance sensors include, for example, a ToF (Time of Flight) type distance sensor. In addition, the design data of the object existing in the imaging range includes, for example, design data of a building where the imaging device 100 is installed. According to the design data, it is possible to acquire a distance from a position where the imaging device 100 is installed to a wall surface of the building existing in the imaging range.

In addition, in the case of a configuration in which a plurality of background distances can be acquired by the distance sensor or the design data of the object existing in the imaging range, a blur changing filter corresponding to a representative value such as an average value, a median value, and a mode value of the background distances can be acquired (specified). According to this configuration, for example, noise included in the acquired background distances can be removed. As the noise, for example, noise due to a measurement error of the distance sensor and disturbance is assumed. Specifically, for example, in the case where the preprocessing shown in FIG. 5 is executed ten times, if an unexpected object exists in the imaging range when one of the ten preprocessing is executed, an appropriate background distance cannot be calculated in the preprocessing and a blur changing filter corresponding to an actual background distance cannot be specified. However, even in this case, the appropriate blur changing filter can be specified based on the background distances calculated in the other nine preprocessing.

When the evaluation value is based on the error, it can be detected that the detection target object exists in the region where the evaluation value is larger than the predetermined value (threshold value). When the evaluation value is based on the correlation, it can be detected that the detection target object exists in the region where the evaluation value is equal to or smaller than the predetermined value (threshold value).

The threshold value used in the evaluation processing may be a value previously held in the image processor 110 or may be a value input and set according to an operation from the user. The threshold value can be input to the evaluation module 113 of the image processor 110 by operating a slide bar or an input key displayed on a display device connected to the image processor 110. In addition, the threshold value may be changed according to a type (a person or an object) of an object to be detected.

In this embodiment, as described above, the evaluation value according to the change in the distance (depth) in the target image can be calculated. Therefore, for example, even when the background and the detection target object are similar colors and it is difficult to detect the presence or absence of the detection target object from a change in the color, the detection target object can be detected (a highly accurate evaluation value can be calculated) without being affected by the color.

In this embodiment, the case where the first filter region 11 is the yellow filter region and the second filter region 12 is the cyan filter region has been described. However, the first filter region 11 and the second filter region 12 can be two different colors among yellow, magenta, and cyan. For example, the first filter region 11 may be the yellow filter region and the second filter region 12 may be the magenta (M) filter region. The magenta filter region has transmittance characteristics of transmitting the light of the red wavelength region corresponding to the R image and the light of the blue wavelength region corresponding to the B image, with high transmittance. In this case, for example, the G image generated from the light of the green wavelength region transmitting only the first filter region 11 and the R image generated from the light of the red wavelength region transmitting both the first filter region 11 and the second filter region 12 are processed as the R image and the G image described in FIGS. 5 and 17, so that the evaluation value can be calculated.

Similarly, the first filter region 11 may be the magenta filter region and the second filter region 12 may be the cyan filter region. In this case, for example, the R image generated from the light of the red wavelength region transmitting only the first filter region 11 and the B image generated from the light of the blue wavelength region transmitting both the first filter region 11 and the second filter region 12 are processed as the R image and the G image described in FIGS. 5 and 17, so that the evaluation value can be calculated.

In this embodiment, the various combinations of the colors of the first filter region 11 and the second filter region 12 have been described. However, in each combination, the colors of the first filter region 11 and the second filter region 12 may be exchanged.

In addition, in this embodiment, for the convenience of explanation, the filter 10 has been described as having a circular shape. However, the filter 10 may have a shape corresponding to the shape of the aperture of the imaging device 100. Specifically, outer circumference of the filter 10 may be formed in a diaphragm blade shape of the imaging device 100 or the filter 10 may have a polygonal shape (for example, a hexagonal shape and an octagonal shape).

The imaging device 100 according to this embodiment can be applied to a monitoring system for monitoring a predetermined area (monitoring area), an automatic door system for controlling opening and closing of an automatic door, and a vehicle control system for controlling driving (an operation) of a vehicle, for example.

In the systems to which the imaging device 100 is applied, an apparatus can be controlled based on the evaluation value regarding the presence or absence of the detection target object in the imaging range or the result of detecting whether or not the detection target object exists.

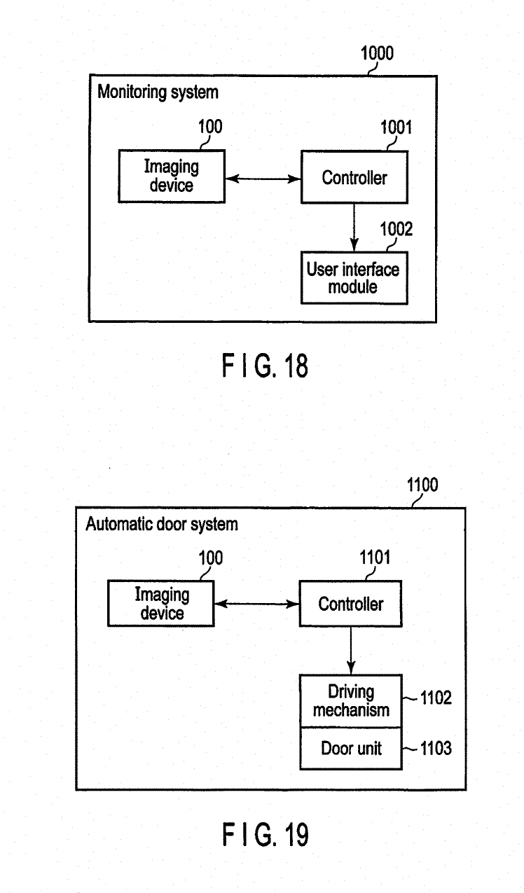

FIG. 18 is a block diagram showing an example of a functional configuration of a monitoring system 1000 to which the imaging device 100 according to this embodiment is applied. Here, it is assumed that the monitoring system 1000 is, for example, a system for monitoring intrusion of a person into a monitoring area. In addition, it is assumed that the monitoring area is normally an area where the intrusion of the person is prohibited.

As shown in FIG. 18, the monitoring system 1000 includes the imaging device 100, a controller 1001, and a user interface module 1002. The imaging device 100 and the controller 1001 are connected via a wired or wireless network, for example.

The controller 1001 causes the user interface module 1002 to display an image of the monitoring area continuously captured by the imaging device 100. The user interface module 1002 executes display processing on a display device, for example. In addition, the user interface module 1002 executes input processing from an input device such as a keyboard and a pointing device. The display device and the input device may be an integrated device such as a touch screen display, for example.

Here, the image processor 110 transmits, to the controller 1001, a signal regarding the calculated evaluation value or a signal regarding a result of detecting whether or not a detection target object exists. The controller 1001 transmits a control signal for controlling the user interface module 1002 to the user interface module 1002, based on the signal. According to this, the controller 1001 can execute processing for notifying a surveillant that the person has intruded into the monitoring area via the user interface module 1002 (for example, processing for issuing an alarm).

In addition, when the evaluation value is larger than the threshold value or when it is detected that the detection target object exists, the imaging device 100 may capture an image with a high image quality to display the detection target object (the person who has intruded into the monitoring area) with high accuracy. The high image quality means that a resolution of the image is high, a frame rate of the image is high, or a compression ratio of image compression is low, for example. In addition, in this case, because it is assumed that the surveillant confirms the image later, a position (frame number) of the image in which it is detected that the detection target object exists may be recorded.

FIG. 19 is a block diagram showing an example of a functional configuration of an automatic door system 1100 to which the imaging device 100 according to this embodiment is applied. As shown in FIG. 19, the automatic door system 1100 includes the imaging device 100, a controller 1101, a driving mechanism 1102, and a door unit 1103.

The imaging device 100 applied to the automatic door system 1100 is installed at a position where a person who passes through an automatic door can be imaged, for example. A signal regarding the evaluation value or the detection result is transmitted to the controller 1101.

The controller 1101 controls the driving mechanism 1102 based on the signal of the imaging device 100. The driving mechanism 1102 has, for example, a motor and conveys driving of the motor to the door unit 1103, thereby opening/closing the door unit 1103, maintaining an opened state, or maintaining a closed state.

According to this automatic door system 1100, when it is detected that an object (for example, a person) exists in the vicinity of the door unit 1103, the door unit 1103 can be driven so that the door unit 1103 switches the opened state from the closed state. In addition, when it is detected that the object exists in the vicinity of the door unit 1103, the door unit 1103 can be driven so that the door unit 1103 remains in the opened state. In addition, when it is detected that the object does not exist in the vicinity of the door unit 1103, the door unit 1103 can be driven so that the door unit 1103 switches the closed state from the opened state. In addition, when it is detected that the object does not exist in the vicinity of the door unit 1103, the door unit 1103 can be driven so that the door unit 1103 remains in the closed state.

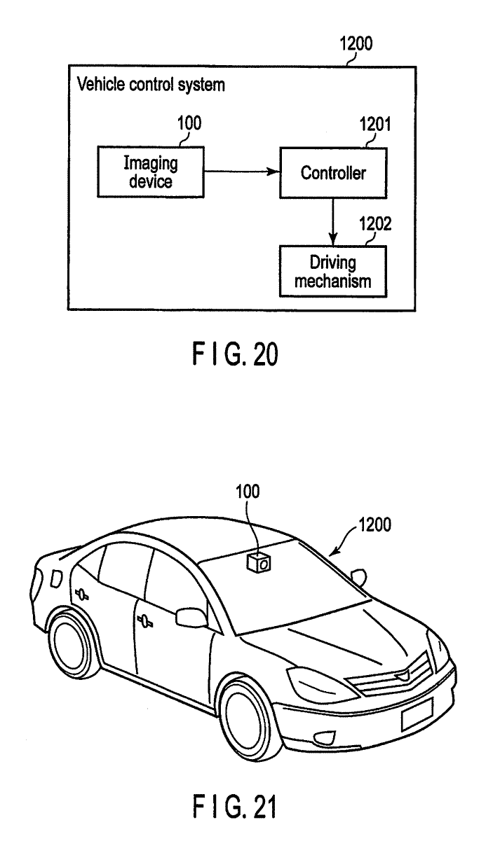

FIG. 20 is a block diagram showing an example of a functional configuration of a vehicle control system 1200 to which the imaging device 100 according to this embodiment is applied. As shown in FIG. 20, the vehicle control system 1200 includes the imaging device 100, a controller 1201, and a driving mechanism 1202. As shown in FIG. 21, the imaging device 100 is installed in the vehicle to image an object existing in a direction of a movement of the vehicle, for example. As an installation form of the imaging device 100 to image the object existing in the direction of the movement of the vehicle, the imaging device 100 may be installed as a so-called front camera to image the front side and may be installed as a so-called rear camera to image the rear side. In addition, the two imaging devices 100 may be installed as the front camera and the rear camera. In addition, the imaging device 100 having a function as a so-called drive recorder may be installed. That is, the imaging device 100 may be a recording apparatus.

In this case, when it is detected that the person exists at the front side or the rear side of the vehicle, based on the evaluation value, the imaging device 100 transmits a signal regarding the evaluation value or the detection result to the controller 1201.

The controller 1201 controls the driving mechanism 1202 for operating the vehicle, based on a signal output from the imaging device 100. For example, when an object (for example, a person) exists at the front side (in the direction of the movement of) the vehicle, the controller 1201 can control the driving mechanism 1202 so that the driving mechanism 1202 does not move the vehicle forward. Similarly, for example, when the object (for example, the person) exists at the rear side of the vehicle, the controller 1201 can control the driving mechanism 1202 so that the driving mechanism 1202 does not move the vehicle backward. The controller 1201 may control the driving mechanism 1202 so that the driving mechanism 1202 changes the direction of the movement of the vehicle during moving.

As described above, in the case where the imaging device 100 is applied to the vehicle control system 1200, for example, when the vehicle stops, the reference image is captured and the preprocessing is executed and when an engine is started to move the vehicle, the evaluation processing is executed, thereby avoiding a situation where the vehicle collides with the object such as the person when the vehicle starts moving.

When the imaging device 100 is used as the recording apparatus, similar to the case of the monitoring system 1000, the imaging device 100 may increase the quality of the image captured by the imaging device 100, based on the evaluation value, and may record the position (frame number) of the image in which it is detected that the object exists.

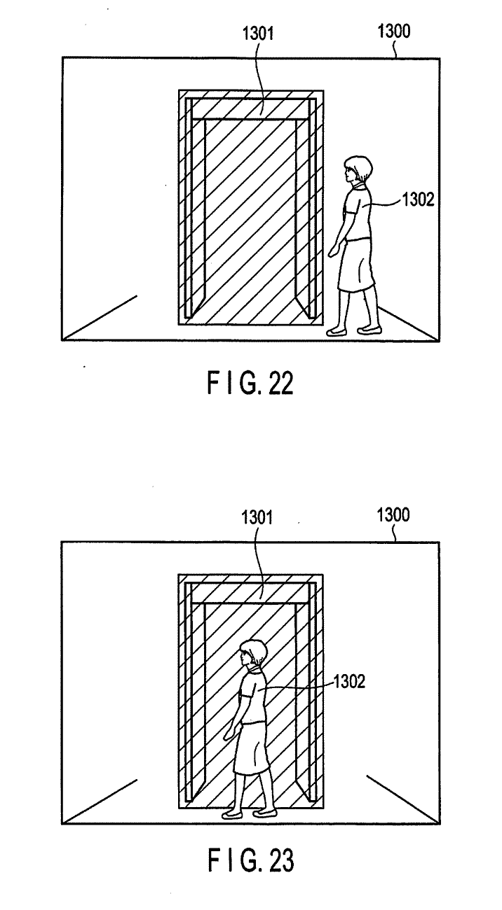

Here, in the monitoring system 1000, the automatic door system 1100, and the vehicle control system 1200, the evaluation value may be calculated (it may be determined whether or not the object exists) not in the entire range of the image captured by the imaging device 100, but in a predetermined subimage. In this case, as shown in FIGS. 22 and 23, for example, an image 1300 captured by the imaging device 100 is displayed and an area (hereinafter, referred to as a monitoring area) 1301 where the evaluation value is calculated can be designated (set) on the image 1300 by the user using the input device. In addition, setting of the monitoring area 1301 can be performed using an apparatus such as a tablet computer.

In this case, for example, as shown in FIG. 22, when a person 1302 exists in the image 1300 but the person 1302 does not exist in the monitoring area 1301, the object is not detected in the imaging device 100. On the other hand, as shown in FIG. 23, when the person 1302 has intruded into the monitoring area 1301, the object is detected in the imaging device 100.

According to this configuration, because the range for calculating the evaluation value is limited, a processing amount (calculation cost) for calculating the evaluation value can be further reduced.

The setting of the monitoring area may be performed with respect to a three-dimensional (3D) point cloud obtained by executing conversion processing on data (distance information) acquired from the distance sensor and RGB images. In this case, for example, an image captured by the imaging device 100 can be rotated and displayed based on the 3D point cloud.

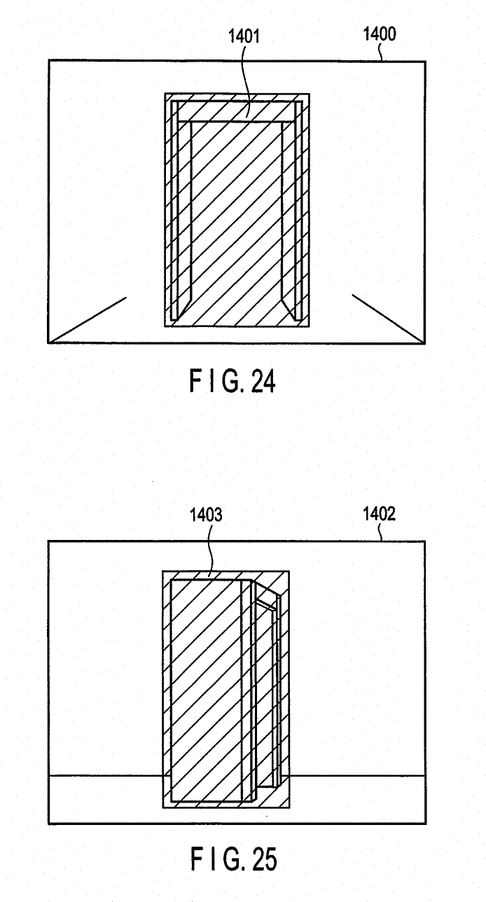

As a result, the user can designate a monitoring area 1401 (reference plane) on an image 1400 shown in FIG. 24 and can designate a monitoring area 1403 (reference plane) on an image 1402 shown in FIG. 25, of which a point of view is different from that of the image 1400. According to this, a three-dimensional area (range) specified by the monitoring areas 1401 and 1403 designated by the user can be specified. The monitoring areas 1401 and 1403 are areas obtained by projecting the three-dimensional area on a plane of a two-dimensional image captured by the imaging device 100, for example. Because a degree of freedom on setting the monitoring area to the three-dimensional point cloud is high, it is possible to set the monitoring area intended by the user more than the setting of the monitoring area 1301 described in FIGS. 22 and 23. In the setting of the monitoring area, voxels may be used.

When the monitoring area can be set as described above, a privacy protection mode may be set to at least a part of an area (range) other than the monitoring area (that is, the privacy protection mode is released in the monitoring area) to protect privacy of a subject (for example, a person) existing outside the monitoring area. When the privacy protection mode is set, mask processing using a black color or processing for lowering the image quality is executed on the area other than the monitoring area.

The imaging device 100 according to this embodiment may be realized as a processing system including the imaging device to capture an image as described above and a processing device to execute the processing shown in FIGS. 5 and 17 on the image captured by the imaging device. The processing system according to this embodiment includes various systems such as the monitoring system, the automatic door system, and the vehicle control system. In this case, when the processing system according to this embodiment is the monitoring system, the processing system may include three devices of the imaging device, the processing device, and the control device including the controller 1001 and the user interface module 1002 shown in FIG. 18. In addition, in the processing system, the processing device and the control device may be configured as an integrated device. The same is also applied to other processing systems.

Although the monitoring system, the automatic door system, and the vehicle control system have been mainly described in this embodiment, the imaging device 100 according to this embodiment may be applied to a system for controlling drones and various robots.

### Second Embodiment

Next, a second embodiment will be described. In this embodiment, an image processor 110 includes a first blur changing module 2603 and a second blur changing module 2604, in addition to an acquisition module 111, a preprocessing module 112, and an evaluation module 113. Because a hardware configuration, a filter, and a functional configuration of an imaging device according to this embodiment are the same as those of the first embodiment, they will be described appropriately using FIGS. 1, 2, and 4. In addition, in the following description, the same parts as those of the first embodiment will not be described in detail and parts different from those of the first embodiment will be mainly described.

In this embodiment, evaluation processing executed on an image captured to detect the presence or absence of an object is different from that of the first embodiment.

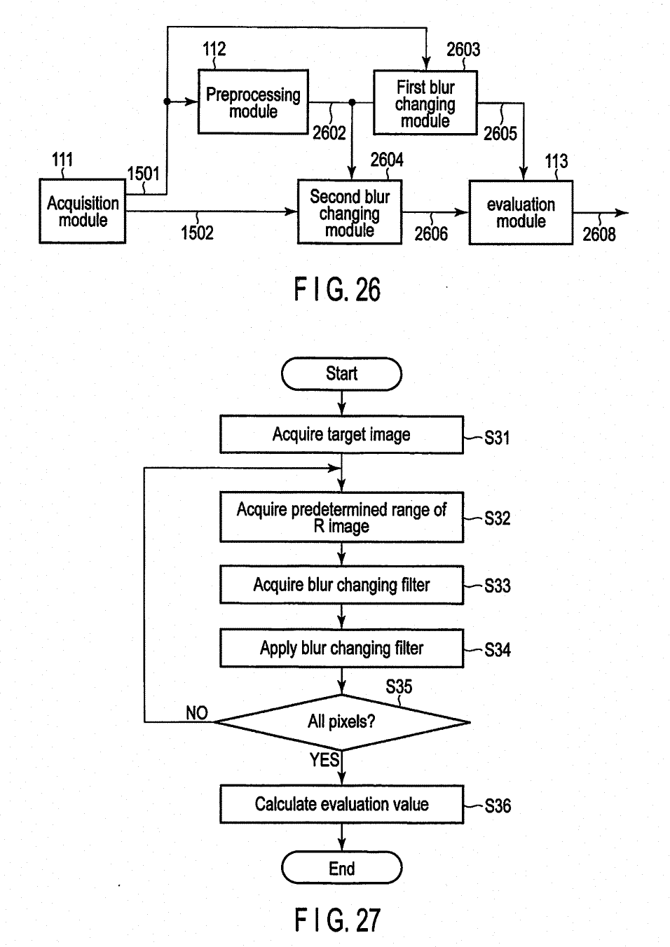

First, an operation of an imaging device 100 according to this embodiment will be conceptually described with reference to FIG. 26.

In this embodiment, when a reference image (image captured when a detection target object does not exist) 1501 is acquired by the acquisition module 111 included in the image processor 110 of the imaging device 100, the preprocessing module 112 executes the preprocessing described in the first embodiment. By executing this preprocessing, a blur changing filter 2602 to approximate a blur function of an R image in the reference image 1501 to a blur function of a G image in the reference image 1501 is specified in each pixel. The reference image 1501 and the blur changing filter 2602 are input to the first blur changing module 2603 and an application result (fourth image) 2605 of the blur changing filter 2602 to each pixel of the R image (first color component image) of the reference image (first image) 1501 is output from the first blur changing module 2603. The application result 2605 is stored in a storage.

On the other hand, when a target image (image captured to detect the presence or absence of a subject) 1502 is acquired by the acquisition module 111, the second blur changing module 2604 outputs an application result (third image) 2606 of the blur changing filter 2602 to each pixel of an R image (second color component image) of the target image (second image) 1502. The application result 2606 is stored in the storage. The application result 2605 and the application result 2606 are input to the evaluation module 113 and an evaluation value 2608 is output from the evaluation module 113. The evaluation value 2608 is a value based on an error or a correlation of the application result 2605 and the application result 2606. As a method of evaluating the error or correlation, the method described above is used.

In the first embodiment, the evaluation value is calculated from the application result of the blur changing filter to the R image of the target image and the G image of the reference image. However, in this embodiment, the evaluation module 113 calculates the evaluation value 2608 from the application result 2605 of the blur changing filter to the R image of the reference image and the application result 2606 of the blur changing filter to the R image of the target image.

Next, an example of a processing procedure of the evaluation processing in this embodiment will be described with reference to a flowchart of FIG. 27. Here, it is assumed that the application result 2605 has been calculated in the same manner as the description given with reference to FIG. 26.

First, processing of step S31 corresponding to the processing of step S11 shown in FIG. 17 is executed.

Next, the second blur changing module 2604 executes processing of the following steps S32 to S34 for each of pixels configuring the target image (for example, the R image). The processing of steps S32 to S34 is processing corresponding to the processing of steps S12 to S14 shown in FIG. 17.

If the processing of step S34 is executed, it is determined whether or not the processing of steps S32 to S34 has been executed for all the pixels (step S35).

When it is determined that the processing is not executed for all the pixels (NO in step S35), the procedure returns to the S32 and the processing is repeated. In this case, the processing is executed for the pixels for which the processing of steps S32 to S34 is not executed.

On the other hand, when it is determined that the processing has been executed for all the pixels (YES in step S35), the blur changing module 2604 calculates an application result 2606 of the blur changing filter to a predetermined subimage including each of the pixels configuring the R image.

Next, the evaluation module 113 calculates the evaluation value from the application result 2605 and the application result 2606 (step S36).

Here, the reference image 1501 and the target image 1502 are images captured via a filter 10 and blurs are observed in edge regions in the images as described above. Assuming that the target image 1502 is captured in a state in which the detection target object exists in the imaging range, a distance (depth) difference of a boundary portion (that is, the edge region) of the object and the background and a color (in this example, an R component) difference (background difference) are reflected in the evaluation value 2608 calculated from the application result 2605 and the application result 2606. In the first embodiment, the evaluation value of the change in the distance (depth) is calculated. However, in this embodiment, the evaluation value in which the color difference of the reference image after applying the blur changing filter and the target image of the same color component as the reference image after applying the blur changing filter is also reflected can be calculated.

That is, in the first embodiment, even when the background and the objects not existing in the background are similar colors, a highly accurate evaluation value can be calculated. However, in this embodiment, when there is the color difference in the background and the object not existing in the background, a highly accurate evaluation value can be calculated.

In this embodiment, the case where the evaluation value is calculated from the application result of the blur changing filter to the R image of the reference image and the application result of the blur changing filter to the R image of the target image has been described. However, the evaluation value may be calculated from the application result of the blur changing filter to the B image of the reference image and the application result of the blur changing filter to the B image of the target image. In addition, the evaluation value may be calculated from the application result of the blur changing filter to the G image of the reference image and the application result of the blur changing filter to the G image of the target image. Here, the blur changing filter approximates a blur function of the color component of the reference image to a blur function of another color component of the reference image. That is, in this embodiment, application results of the blur changing filter to a common color component included in the reference image and the target image may be compared with each other.

In addition, the evaluation value may be calculated from the application result of the blur changing filter to the R image included in the reference image and the application result of the blur changing filter to the G image of the target image. In addition, the evaluation value may be calculated from the application result of the blur changing filter to the R image included in the reference image and the application result of the blur changing filter to the B image of the target image. In addition, the evaluation value may be calculated from the application result of the blur changing filter to the G image included in the reference image and the application result of the blur changing filter to the R image of the target image. In addition, the evaluation value may be calculated from the application result of the blur changing filter to the G image included in the reference image and the application result of the blur changing filter to the B image of the target image. In addition, the evaluation value may be calculated from the application result of the blur changing filter to the B image included in the reference image and the application result of the blur changing filter to the R image of the target image. In addition, the evaluation value may be calculated from the application result of the blur changing filter to the B image included in the reference image and the application result of the blur changing filter to the G image of the target image. Here, the blur changing filter approximates a blur function of the color component of the reference image to a blur function of another color component of the reference image.

In addition, the case where the blur changing filter is applied to only the R image in the processing shown in FIG. 27 has been described. However, a blur changing filter to approximate the blur function of the B image to the blur function of the G image is specified, the blur changing filter is applied to each of the R image and the B image, two evaluation values are calculated, and an average value of the two evaluation values may be used as a new evaluation value. According to this configuration, a highly accurate evaluation value can be calculated as compared with the case where the blur changing filter is applied to only the blur shape of the R image. Also, a configuration where a blur changing filter to approximate the blur function of the G image to a blur function of another color component is specified, the blur changing filter is applied to each of the R, G, and B images, three evaluation values are calculated, and an average value of the three evaluation values is used as a new evaluation value can be adopted. In addition, a configuration where the blur changing filter is not applied to only the G image, three evaluation values are calculated from the R, G, and B images, and an average value of the three evaluation values is used as a new evaluation value can be adopted.

According to at least one embodiment described above, it is possible to provide a processing device, a processing system, a method, and a program capable of reducing a calculation cost for detecting the presence or absence of an object.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A processing device comprising:
a storage configured to store a third image and a third color component image, the third image being obtained by applying a blur changing filter to a second color component image included in a second image, the blur changing filter changing a blur shape of a first color component image included in a first image, the third color component image being included in the second image; and
a hardware processor configured to calculate an evaluation value, based on the third image and the third color component image.

2. The processing device according to claim 1, wherein at least one of a blur shape of the second color component image and a blur shape of the third color component image is non-point symmetric.

3. The processing device according to claim 1, wherein
a blur shape of a fourth image obtained by applying the blur changing filter to the first color component image is closer to the blur shape of the third color component image included in the first image than the blur shape of the first color component image.

4. A processing device comprising:
a storage configured to store a fourth image obtained by applying a blur changing filter to a first color component image included in a first image and a third image obtained by applying the blur changing filter to a second color component image included in a second image; and
a hardware processor configured to calculate an evaluation value, based on the third image and the fourth image.

5. The processing device according to claim 1, wherein the first image and the second image are captured by an image sensor configured to generate an image including a color component of which a blur function is symmetric and a color component of which a blur function is non-symmetric.

6. The processing device according to claim 1, wherein at least parts of a wavelength range of the first color component and a wavelength range of the second color component overlap each other.

7. The processing device according to claim 1, wherein the hardware processor is configured to detect an object in the second image, which does not exist in the first image or exists at a position different from a position of the first image, based on the evaluation value.

8. The processing device according to claim 1, wherein the hardware processor is configured to detect an object in a designated region in the second image, which does not exist in the first image or exists at a position different from a position of the first image.

9. The processing device according to claim 1, wherein the hardware processor is configured to detect a range where an object in the second image, which does not exist in the first image or exists at a position different from a position of the first image, exists based on the evaluation value and a threshold value.

10. A processing system comprising:
an imaging device; and
a processing device connected to the imaging device, wherein
the processing device comprises
a storage configured to store a third image and a third color component image, the third image being obtained by applying a blur changing filter to a second color component image included in a second image, the blur changing filter changing a blur shape of a first color component image included in a first image, the third color component image being included in the second image and
a hardware processor configured to calculate an evaluation value, based on the third image and the third color component image.

11. The processing system according to claim 10, further comprising a controller configured to output a control signal to control a driving mechanism, based on the evaluation value.

12. The processing system according to claim 11, wherein
the driving mechanism is included in a vehicle and
the controller is configured to control the driving mechanism so that the driving mechanism does not move the vehicle forward or backward or changes a direction of a movement of the vehicle.
